(19) United States
(12) Patent Application Publication
(10) Pub. No.: US 2024/0131983 A1
(43) Pub. Date: Apr. 25, 2024

(54) EXTERIOR GLASS TRIM ELEMENT FOR VEHICLE

(71) Applicant: AGC GLASS EUROPE, Louvain-la-Neuve (BE)

(72) Inventor: Edouard BOUTENS, Courtrai (BE)

(73) Assignee: AGC GLASS EUROPE, Louvain-la-Neuve (BE)

(21) Appl. No.: 18/546,507

(22) PCT Filed: Feb. 17, 2022
(86) PCT No.: PCT/EP2022/053997

§ 371 Date: Aug. 14, 2023

(30) Foreign Application Priority Data
Feb. 17, 2021 (EP) 21157710.1

(51) Int. Cl. B60Q 1/50

(52) U.S. Cl. CPC B60Q 1/50; B60Q 2400/50

(57) ABSTRACT

An exterior trim element for a motor vehicle, including a glass cover disposed on a support member, the glass cover having an outer face and an inner face. A display system for projecting an image is integrated to a cover part on the inner face of the glass cover glass.

The invention relates to an exterior glass trim element for a motor vehicle. In particular, it may be in the design part of a A-, B- and C-pillar of a motor vehicle. More particularly, the present invention concerns an exterior glass trim element provided with an integrated display system.

The vehicle of today and of tomorrow are not only means of locomotion. They are used for pleasure, for sharing experiences. They are more and more autonomous and expected to be in future “a mobile room/office” circulating from a point A to a point B. Consequently, vehicles should be more and more safe by for example sharing information from one vehicle to another vehicle or from one driver to another driver or occupant of the vehicle. In the future, safety warning message, like a close accident, traffic jam, an object on the road should be visible by the vehicle following another one while both drivers are driving.

Also, in order to decrease the carbon footprint, vehicles and more particularly cars are more and more shared. Carsharing will probably become the norm for transportation. Today, they are more and more actors in this carsharing scene. Even, the car manufacturers are actors in this carsharing scene. By projecting indications on the sidewalk, it will be easier for people to find their reserved car or discover new ridesharing options.

To decrease the carbon footprint or even to generate money from the vehicle, the vehicle itself may be used for advertising. Today, to make advertising through the vehicle, either a display like a LED/LCD screen is used either and more commonly stickers provided on the car body. However, these two solutions have some drawbacks. The use of screen is expensive and increase the weight of the vehicle while the decrease for reducing carbon footprint is sought; Concerning the stickers, they have to be changed when the ad is no longer relevant. Also, they may be easily damaged leading to unaesthetic vehicle.

Thus, there is a need to have a simple way to use the vehicle itself for sharing information from a vehicle to another vehicle or from a driver to another driver, for having a solution to decrease the carbon footprint as an alternative to stickers, banners or flyers.

In view of the foregoing prior art problems, it is an object of the present invention to provide a glass exterior trim element for vehicle to project images or a movie on an exterior surface like a road, sidewalks, the image being visible not only by the vehicle's passengers but also people outside the vehicle.

Thus, the present invention concerns an exterior trim element for a motor vehicle, comprising a glass cover disposed on a support member, the glass cover having an outer face and an inner face characterized in that a display system for projecting an image is integrated to the cover part on the inner face of the glass cover.

More particularly, the present invention proposes glass trim element for A, B- and C-pillar, fender of a vehicle.

The solution as proposed in the present invention allows to use the vehicle itself as a mean to:
share information for safety reason to people being outside the vehicle by projecting images on the road such as “accident in x meters or kilometers”, “traffic information”, issue with the vehicle . . . . Thus, a driver from another vehicle or people close the vehicle projecting the image can see it and react consequently.
project an advertisement on the road, on sidewalks, or another surface like a wall. Thus, the car will be an ecological alternative to plastic or paper banners, flyers.
project an information from a shared car in the carsharing scene, the projected on sidewalks or the road or an exterior surface.

According to one embodiment of the present invention, the display system projects an image towards the outside of the motor vehicle.

Thus, for safety reasons, an image may be projected on the road or sidewalks to warn about an close accident, an object on the road, a traffic jam. The image is then visible to anyone being close to the vehicle projecting the image. The image may be from example the navigating system of the vehicle or from the warning system of the vehicle in case of a damage . . . .

Also, from a car shared, an information such as a localization, the availability of the vehicle, the next scheduled destination . . . may be projected on the road, or a sidewalks or a surface close to the vehicle. The information is then easily and quickly available.

The image projected by the vehicle may be also an advertisement or a public information. The vehicle is a then more efficient that a classical advertisement placed on a panel and more ecological. Furthermore, a projected image captures more attention that a banner fixed generally too high. The image is also more broadly diffused.

According to one embodiment of the present invention, the display system integrated to the cover part on the inner face of the cover glass of an exterior trim element has an integrated light emitting diodes (LED) projector.

It is understood that in the rest of the following description, the term LEDs means Light emitting diodes, the two may be used.

More preferably, the LED projector comprises multiple colored LED. The power of the LED and the luminous flux are high enough to project an image visible to a people being outside the vehicle projecting the image without dazzling. Thus, the type of LEDs are chosen according to their performances. Preferably, the image is projected at a distance of 0.5-2 meters from the projecting vehicle.

LED projectors run cooler, consume less energy, have more accurate color and can last longer without a replacement bulb than a traditional projector, making them ideal in many ways for use in an business environment.

According to one embodiment of the present invention, the display system integrated to the cover part on the inner face of the cover glass of an exterior trim element, has an integrated hybrid projector combining lasers and LEDs.

The Laser/LED Hybrid illumination technology is a breakthrough in the way a projector manipulates light and images, resulting in superb picture quality with high contrast ratio for greater details. The LEDs and lasers combine as a light source to create vibrant rich color, by generating a color spectrum far greater than that of normal mercury light projector which rely on a color wheel and may show ghost images and rainbow effects. Furthermore, the Laser/LED Hybrid illumination technology is an eco-friendly technology since lamp free.

Laser/LED Hybrid illumination technology delivers a longer light source life of up to 20,000 hours and is much more energy efficient utilizing intelligent power control, generating nearly twice as many lumens per watt as a lamp based projector. Furthermore, these projectors do not get hot to the touch, and are faster and quieter to switch on and off, as well as offering a more stable design.

According to one embodiment of the present invention, the display system integrated to the cover part on the inner face of the cover glass of an exterior trim element, has an integrated laser phosphor projector.

Cost-effective Laser Phosphor projectors use an array of blue laser LEDs to create the blue color in the final image, but another blue laser is also used to illuminate a yellow phosphor wheel, which emits the yellow light. This yellow light is then split by a filter into green and red light components.

According to another embodiment of the present invention, to the cover part on the inner face of the cover glass of an exterior trim element, has an integrated RGB laser beamer.

RGB laser projection technology uses individual red, green and blue lasers to generate light, which produces the most dynamic color available today. Pushing the boundaries of color reproduction, brightness, image uniformity, and operational lifetime, RGB pure laser represents a good projector illumination technology.

Thus, the projection light source, as a device for displaying information, such as characters, images, etc., is connected to relevant instruments, external sensors, external smart devices, etc. of the automobile or an external device such as a mobile phone, and projects relevant character, image information such as an advertisement, a relevant information, a warning message such that the information is visible to the observer outside the automobile. The projection light source is an element known by persons skilled in the art, including but not limited to a laser, a light emitting diode (LED), a liquid crystal display (LCD), an electroluminescent (EL) element, a cathode-ray tube (CRT), a vacuum fluorescent tube (VFD), a collimating mirror, a spherical mirror, a convex lens, a concave lens, a reflector, and/or a polarizer, etc. Meanwhile, the location and incident angle of the projection light source is adjustable, so as to be adapted to the observer in different locations or heights outside the automobile.

According to the present invention, the display system for projecting have a size compatible with its integration into an exterior trim element.

According to one embodiment of the present invention, glass cover of the exterior trim element is provided with a zone transparent to visible light, the said beamer being placed in the said zone. The trim element is a preferred embodiment is provided on at least a part of its surface with a layer opaque to the visible light for aesthetic reasons or for protect from UV some components of the trim element.

Thus, the exterior trim element may be provided with special glass pain or ink/enamel backing for aesthetic reasons. A colored paint or enamel may be provided on at least a part of the surface the inner face of the glass cover. Then, a zone transparent to the visible light more particularly a zone free of colored paint/ink or enamel is provided. The display system according to the present invention is then placed within the transparent zone to the visible light, thus the light from the projector source may be go through and an optimal image may be projected from the vehicle to the outside and more particularly on the floor or a wall to be visible to people being outside the vehicle.

According to one embodiment of the present invention, the exterior trim element may host different functionalities around electronic gadgetry and vehicle control information, for example.

According to the invention, the cover part is mounted on the support member and preferably on any part in the exterior vehicle to be covered in order to provide a better aesthetic or to secure some part of the exterior's vehicle. Particularly, the trim element according to the present invention covers some parts of A, B- and C-pillar of the exterior's vehicle.

In a preferred embodiment of the invention, the trim element is made of in one piece of glass sheet extended along the part to be covered.

According to another embodiment of the invention, the trim element can be made of several pieces of glass sheet, depending on the needs for harboring functions.

According to the invention, the cover part of the trim element is made of flat glass sheet which can be bended or thermoformed to adapt with the shape of the car. The flat glass sheet may be processed to be decorative or in order to give an access to auxiliary power point, etc.

According to a preferred embodiment of the present invention, the trim element made of glass is hot bended. It is foreseen to use the “applique” on all car pillars (A, B, C and D). Even if the curvature of the A, B and C-pillar looks very cylindrical, in most cases it is a 3D-bended part. Especially the shape of a cover for the D-pillar could be very complex and very large. In many cases, this shape is strongly bended (to close the gap between the rear side glass (QLF) and the backlite of the carbody). To achieve this shaping, a “hot bending” process is preferable.

According to another embodiment, the trim element may be cold bended.

The glass according to the invention is made of glass which can belong to various categories. The glass can thus be a glass of soda-lime-silica, aluminosilicate or borosilicate type, and the like. Preferably and for reasons of lower production costs, the glass sheet according to the invention is a sheet of soda-lime-silica glass.

According to another advantageous embodiment of the invention, which may be combined with the preceding embodiment, the glass sheet can be coated with a layer or a film which makes it possible to modify or neutralize the colour which may be generated by for example the presence of the chromium (for example a coloured PVB film).

The glass sheet according to the invention may advantageously be chemically or thermally tempered in order to enhance the resistivity of the cover part of the exterior trim element.

According to one embodiment of the invention, the glass sheet is coated with at least one transparent and electrically conducting thin layer. A transparent and conducting thin layer according to the invention can, for example, be a layer based on SnO2:F, SnO2:Sb or ITO (indium tin oxide), ZnO:Al or also ZnO:Ga.

According to another advantageous embodiment of the invention, the glass sheet is coated with at least one antireflection layer. An antireflection layer according to the invention may, for example, be a layer based on porous silica having a low refractive index or it may be composed of several layers (stack), in particular a stack of layers of dielectric material alternating layers having low and high refractive indexes and terminating in a layer having a low refractive index. A textured glass sheet may be also used. Etching or coating techniques may as well be used in order to avoid reflection.

According to another embodiment, the glass sheet is coated with at least one anti-fingerprint layer or has been treated so as to reduce or prevent fingerprints. Such a layer or such a treatment may be combined with a transparent and electrically conducting thin layer deposited on the opposite face. Such a layer may be combined with an antireflection layer deposited on the same face, the anti-fingerprint layer being on the outside of the stack and thus covering the antireflection layer.

According to the applications and/or properties desired, other layers can be deposited on one and/or the other face of the glass sheet according to the invention.

The glass sheet according to the invention may be a glass sheet obtained by a floating process, a drawing process, a rolling process or any other process known to manufacture a glass sheet starting from a molten glass composition. According to a preferential embodiment according to the invention, the glass sheet is a float glass sheet. The term “float glass sheet” is understood to mean a glass sheet formed by the float glass process, which consists in pouring the molten glass onto a bath of molten tin, under reducing conditions. A float glass sheet comprises, in a known way, a “tin face”, that is to say a face enriched in tin in the body of the glass close to the surface of the sheet. The term “enrichment in tin” is understood to mean an increase in the concentration of tin with respect to the composition of the glass at the core, which may or may not be substantially zero (devoid of tin).

The glass sheet according to the invention can have a thickness varying between 0.1 and 5 mm. Advantageously, the glass sheet according to the invention may have a thickness varying between 0.1 and 3 mm. Preferably, for reasons of weight, the thickness of the glass sheet according to the invention is from 0.1 to 2.2 mm.

According to the invention, the glass sheet may be totally or partially curved to correctly fit with the particular design of the vehicle.

In order to provide a better esthetic of the exterior vehicle, the trim element may be made of a digital or silk screen printed glass sheet, an etched glass sheet, a painted/enameled glass sheet, a casted glass sheet, an anti-bacterial glass sheet, a colored float glass sheet.

According to another embodiment of the invention, the cover part is made of laminated glass sheet. According to this embodiment, at least one thermoplastic interlayer is used to laminate at least two glass sheets. Advantageously, a colored or active interlayer may be present between the at least two glass sheets.

According to another embodiment of the invention, the at least one trim element is made of heat treated glass sheet, for example annealed or tempered and/or bended glass sheet. Typically, this involves heating the glass sheet (coated or not) in a furnace to a temperature of at least 580° C., more preferably of at least about 600° C. and still more preferably of at least 620° C. before rapidly cooling down the glass substrate. This tempering and/or bending can take place for a period of at least 4 minutes, at least 5 minutes, or more in different situations.

In a preferred embodiment of the present invention, the at least one trim element is made of an annealed glass sheet. During the glass production process, the molten glass is cooled down slowly and under carefully controlled conditions. This annealing process is able to remove undesirable stresses inside the glass. In case of an impact (breakage) the annealed glass will break into small and larger glass parts. As there is no internal stress inside the glass, all these broken glass parts will be fixed to the glue on the backplate. By this, broken glass part will stay on the applique and cannot harm people after an impact in comparison with tempered glass (or semi-tempered or chemically tempered). Indeed, due to the tempering process the glass is forced to cool down rapidly under carefully controlled conditions. This rapid cooling process leaves the center of the glass relatively hot compared to the surfaces. As the center cools down later it forces the surface and the edges into a high compression stress. Thus, if tempered glass breaks, it will shatter into many small splinter. Because of the sudden release of the high inner glass stress, there is a risk, that the glass splinter will not be fully kept by the glue of the appliques, thus resulting in a risk to harm people.

Other advantages of the present invention will be readily appreciated with reference to the following accompanying drawings wherein:

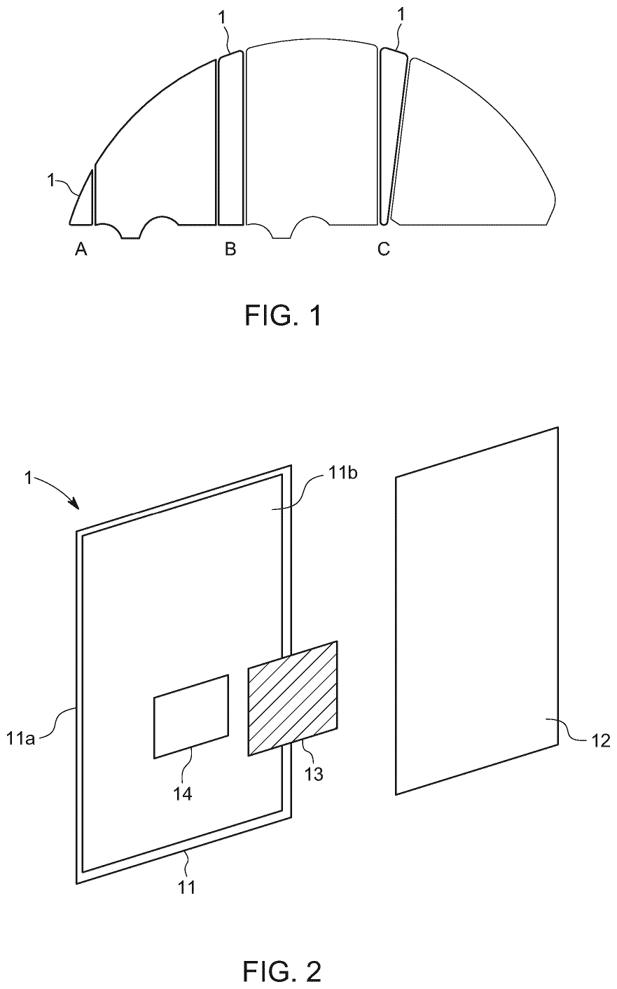

FIG. 1 shows examples of possible locations of a trim element according to the present invention.

FIG. 2 shows an exterior trim element provided with a projecting device according to one embodiment of the present invention.

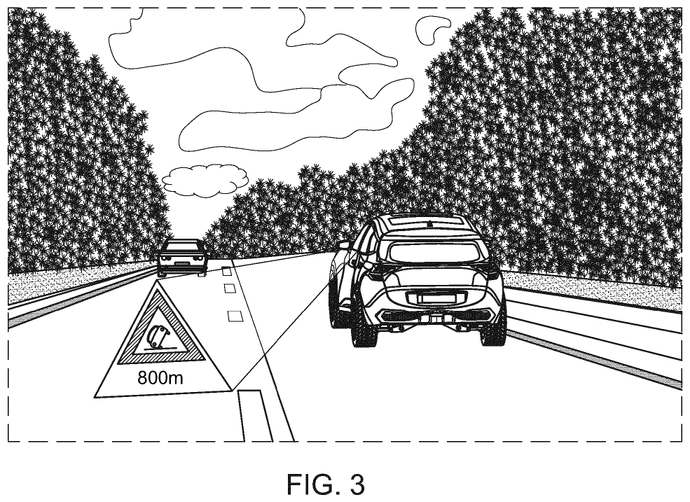

FIG. 3 shows an warning massage projected from the trim element according to the present invention.

FIG. 1 show an exterior trim element 1 according to the present invention applied in A-, B- and C-pillars; A- and B-pillars being separated by the front door glass and B- and C-pillars being separated by the rear door glass.

According to one embodiment of the present invention, the exterior trim element 1 comprises a glass cover 11 disposed on a support member 12, the glass cover 11 having an outer face 11a and an inner face 11b.

According to the present invention, a display system for projecting an image 13 is integrated to the glass cover 11 on the inner face 11b of the glass cover 11.

According to one embodiment of the present invention, the cover glass is made of semi-tempered or annealed glass with a thickness of 1.6 mm. the cover glass may be a laminated glass.

For an aesthetic aspect, the inner face 11b of the glass cover 11 is at least partially covered with a black print or a layer opaque to the visible light 14 except the zone 11c which is free of black print to allow the light from the display system 13 to project through this transparent zone 11c.

According to this example, the a display system for projecting an image 13 is an RGB laser projector. The display 13 is placed in order to project an image towards the outside of the motor vehicle. Thus, an image can be projected on the sidewalk or a wall or the road to be visible to people being outside the vehicle. The image may be an adverting, a warning message . . . .

According to another embodiment of the present invention, the display system 13 projecting an image may be provided into an opening providing in the glass cover 11.

The display system 13 has dimensions suitable to be integrated between the glass cover 11 and the car body.

The FIG. 3 shows a warning image projected on the floor of the road from the trim of the vehicle. The image is then visible by the other divers to prevent further accident.

Thus, the trim element (also called applique) may become the interface between vehicle and people being outside the vehicle.

According to the present invention, the support member may have additional functional properties to improve the resistance of the trim element. The support member may comprise all means to fix the trim element to the vehicle body and/or to seal the trim element.

The support may be as described in the published patent application WO2017158031.

1. An exterior trim element for a motor vehicle, comprising a glass cover disposed on a support member, the glass cover having an outer face and an inner face
wherein a display system for projecting an image is integrated to a cover part on the inner face of the glass cover glass.

2. The exterior trim element according to claim 1, wherein the display system projects an image towards an outside of the motor vehicle.

3. The exterior trim element according to claim 1, wherein the display system has an integrated light emitting diode projector.

4. The exterior trim element according to claim 1, wherein the display system has an integrated hybrid projector combining LEDs and laser diodes.

5. The exterior trim element according to claim 1, wherein the display system has an integrated laser phosphor projector.

6. The exterior trim element according to claim 1, wherein the display system has an integrated RGB laser beamer.

7. The exterior trim element according to claim 1, wherein the display system generates a light having at least one color selected from a group comprising red, green and blue or a mixture thereof.

8. The exterior trim element according to claim 1, wherein the glass cover is provided with comprises a zone transparent to visible light, the said and
wherein a beamer is positioned being placed in said zone.

9. The exterior trim element according to claim 1, the trim element having on at least a part of its surface an opaque layer that is opaque to to the visible light.

10. The exterior trim element according to claim 9, wherein the opaque layer is a black ink, a black paint, or a black enamel.

11. The exterior trim element according to claim 9, wherein the opaque layer is on at least a part of the inner face of the glass cover.

12. The exterior trim element according to claim 1, further comprising an opening in which a beamer is placed.

13. The exterior trim element according to claim 1, wherein the glass cover is a thermal tempered or a chemical tempered glass.

14. The exterior trim element according to claim 1, wherein the glass cover is a laminated glass.

15. The exterior trim element according to claim 1, wherein the glass cover is a soda-lime, an aluminosilicate, or a borosilicate glass having a thickness of 0.1 to 5 mm.
